(19) United States
(12) Patent Application Publication
(10) Pub. No.: US 2011/0172019 A1
(43) Pub. Date: Jul. 14, 2011

(54) METHOD AND SYSTEM FOR PLAYING A HAND-TO-HAND COMBAT SPORT

(76) Inventor: Bogatin Jeffrey, New York, NY (US)

(21) Appl. No.: 12/685,230

(22) Filed: Jan. 11, 2010

(51) Int. Cl. A63C 19/00; G06F 19/00

(52) U.S. Cl. 472/93; 700/92

(57) ABSTRACT

The present invention is directed to an improved method for playing a hand-to-hand combat sport, including providing a fighting area comprising a fighting surface wherein the fighting surface is subdivided into a plurality of zones and scoring the match according to a predetermined set of rules that accounts for the location of the fighters with respect to the zones. The present invention further relates to a method for broadcasting a hand-to-hand combat sport in which an audio and/or video signal depicting the match is transmitted to a remote audience along with statistical information concerning the fight. The present invention further relates to an improved fighting area for conducting a hand-to-hand combat sport including a raised platform that is subdivided into a plurality of zones including: (i) a first zone situated at the center of the boxing area; and (ii) one or more zones surrounding said first zone.

### FIELD OF THE INVENTION

The present invention relates to a system and method for playing a hand-to-hand combat sport such as boxing.

### SUMMARY OF THE INVENTION

One embodiment of the present invention comprises a method for playing a hand-to-hand combat sport comprising the steps of providing a fighting area comprising a fighting surface wherein the fighting surface is subdivided into a plurality of zones including at least: (i) a first zone situated at the center of the fighting area and (ii) one or more zones surrounding the first zone which comprise the remainder of the fighting surface; scoring the match according to a predetermined set of rules; awarding a standard number of points based on performance to a fighter while the fighter is fighting in the first zone; awarding less than standard points based on performance to a fighter when the fighter is fighting in a zone other than the first zone, and deducting points when a fighter has retreated to a zone other the first zone to avoid, delay or stall the match.

In at least one embodiment, the fighting surface is divided into three zones.

In at least one embodiment, the fighting surface is divided into a plurality of non-concentric adjacent segments.

In at least one embodiment, the points awarded while fighting in the third zone are less than the points awarded in the second zone.

In at least one embodiment, the hand-to-hand combat sport is boxing.

In at least one embodiment, a scoring computer is used to score the match.

In at least one embodiment, the hand-to-hand combat sport is a sport chosen from the list of mixed martial arts, judo, karate, taekwondo, jujitsu, and wing chun.

In at least one embodiment, the hand-to-hand combat sport is boxing.

In at least one embodiment, the opinion of the live or televised audience is factored into the scoring of the match.

Another embodiment of the present invention comprises A method of broadcasting a hand-to-hand combat match comprising the steps of providing a fighting area comprising a fighting surface wherein the fighting surface is subdivided into a plurality of zones including at least: (i) a first zone situated at the center of the fighting area and (ii) one or more zones surrounding the first zone which comprise the remainder of the fighting surface; scoring the match according to a predetermined set of rules; awarding a standard number of points based on performance to a fighter while the fighter is fighting in the first zone; awarding less than standard points based on performance to a fighter when the fighter is fighting in a zone other than the first zone; deducting points when a fighter has retreated to a zone other the first zone to avoid, delay or stall the match; and transmitting an audio and/or visual signal depicting the match.

Another embodiment of the present invention comprises a hand-to-hand combat fighting area comprising a raised platform substantially covered with a layer of padding; a plurality of posts surrounding said platform at regular intervals; means for connecting said posts; wherein said posts and said means for connecting said posts define a fighting area that comprises a fighting surface; wherein said fighting surface is subdivided into a plurality of zones including: (i) a first zone situated at the center of the boxing area; and (ii) one or more zones surrounding said first zone.

In at least one embodiment, the means for connecting said posts is a plurality of padded ropes extending between said posts.

In at least one embodiment, the means for connecting said posts is a fence.

In at least one embodiment, the raised platform has more than four sides.

Other features and advantages of the present invention will become readily apparent from the following detailed description, the accompanying drawings and the appended claims.

### BRIEF DESCRIPTION OF THE DRAWINGS

Exemplary embodiments of this invention will be described with reference to the accompanying figures.

FIG. 1 is a plan view of a boxing ring floor according to an embodiment of the present invention.

FIG. 2 is a plan view of a boxing ring floor according to an embodiment of the present invention.

### DETAILED DESCRIPTION OF THE EXEMPLARY EMBODIMENTS

The present invention is related to a new system and method of playing a hand-to-hand combat sport such as boxing, wrestling, mixed martial arts (“MMA”), and the like. In these hand-to-hand combat sports, fighters may retreat to the corners of a fighting area to rest and recover from fatigue or otherwise stall the action. A fighter may also “grab” an opponent for support and a brief period of rest, which can further delay the action. Such delays in the action generally make the sport less exciting and interesting to the live and television audiences, who may turn to other forms of entertainment. The presence of the fighters at the periphery of the fighting area also limits the view of spectators and can make it difficult for the television network to provide a clear view of the action to the television audience. Further, a fighter who believes that he is ahead on points may avoid engaging his opponent toward the end of the match, which can lead to a less interesting match. Further still, the present manner of scoring such matches encourages close decisions and often fails to convey the decisiveness of the victory or difference in abilities of the fighters.

Accordingly, there is a need for an enhanced version of these types of hand-to-hand combat sports in which the action is centered in the middle of the fighting area and with fewer delays due to fighters retreating to the corner and grabbing opponents for rest. Specifically, the system of the present invention includes several novel enhancements that can be applied to a variety of hand-to-hand combat sports, including a fighting area divided into a plurality of zones and a unique scoring system. The scoring system of the present invention awards or deducts points depending on the zone in which the fighter is fighting and thus provides enhanced entertainment value because the fighters are encouraged to fight in the center of the fighting area, in full view of the television cameras and live spectators, and discouraged from retreating to corners or otherwise delaying the action.

A boxing ring according to an embodiment of the present invention comprises a floor that is a raised square platform between approximately 16 and 25 feet in length on each side. A plurality of parallel ropes covered by a soft material may be attached to a post at each corner and enclose the ring, defining a fighting area. The floor of the boxing ring extends slightly beyond the ropes on all sides and preferably between 18 and 24 inches. The floor of the boxing ring may be padded with a layer of foam such as Ensolite or any other suitable foam that is durable, light weight and non-absorbent. The padding layer may be covered with a top layer of canvas or other heavy, woven fabric that is tightly stretched and secured in place. The boxing ring floor defines a fighting surface.

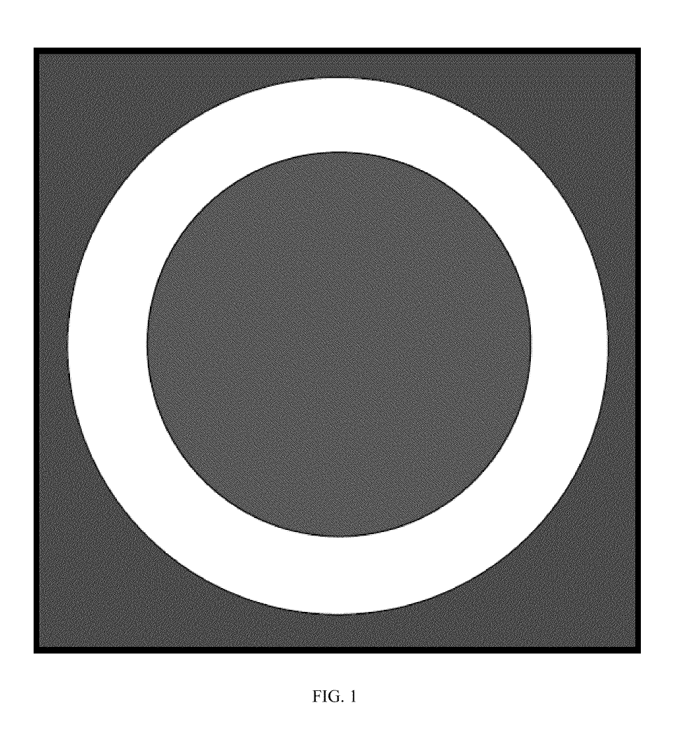

As shown in FIG. 1, a fighting surface is marked so as to be divided into three zones, namely a Blue Zone, White Zone, and Red Zone.

In an embodiment, the Blue Zone is a circle that measures approximately 10 feet in diameter in the center of the ring and is the main fighting area of the ring. The White Zone is a second zone that circles the Blue Zone and, in an embodiment, is approximately 10 feet in width. The White Zone is painted a different color than the Blue Zone. A Red Zone comprises the remainder of the fighting area and is painted a different color than the Blue Zone or the White Zone. In an embodiment, the White Zone and Red Zone are painted in conspicuous colors, such as red for the Red Zone and white for the White Zone, to warn the fighters that they are not in the Blue Zone. In an embodiment, two zones are provided, namely, a Blue Zone in the center of the fighting area and a Red Zone comprising the remainder of the fighting area. In a further embodiment, more than three zones may be provided. In a further embodiment, the zones may be in the shape of a square or triangle or any other polygon.

As discussed in more detail below, the scoring system of the present invention encourages fighters to fight primarily in the Blue Zone and discourages fighting in zones other than the Blue Zone, thereby enhancing the entertainment value of the sport.

In an embodiment, a boxing match may be scored generally in accordance with a modified version of the “Ten Point Must System” that has been adapted to take advantage of the unique divisions of the fighting surface. The Ten Point Must System will be familiar to persons of skill in the art.

In an embodiment, fighters are awarded points in each round of the match based upon an evaluation of four performance criteria with each criterion counting for one quarter of the score for a given round. The criteria include clean punching, effective aggression, ring generalship and defense.

Clean punching is a measure of punches thrown and landed, as well as the strength of those punches. Effective aggression is a measurement of the general level of aggression against an opponent while landing clean punches. Ring generalship measures how much a fighter is in control of the ring. Defense measures how effectively a fighter is able to defend against punches from the opponent by blocking, ducking, backing up, etc.

A boxing match comprises multiple rounds and may be scored round-by-round by a panel of judges, preferably three. In each round, each judge awards a score to each fighter by taking into consideration each of the four criteria mentioned above, as well as the position of the fighter in the fighting area. The winner of the match is the fighter with the most total points at the conclusion of the match.

Under the scoring system of an embodiment of the present invention, if the fighting is substantially contained within the Blue Zone during the round, the winner of the round is awarded ten points and the loser is awarded nine points. If a fighter is knocked down, that fighter loses a point for each time the fighter is knocked down. In the event that a fighter wins a round by a wide margin, the judges may deduct an additional point from the losing fighter for that round to award the dominating fighter. Such a judgment is subjective and it is not required that an additional point be deducted.

In addition to the foregoing scoring guidelines, in an embodiment, should a fighter move outside the Blue Zone to the White Zone, the judges may factor that into their scoring if the fighter is using the White Zone to avoid, delay or stall the action. White Zone boxing carries less value than Blue Zone boxing and the judges may deduct points for retreating to the White Zone or award fewer points than would be awarded in the Blue Zone. Should a fighter move further still from the White Zone to the Red Zone, the judges may factor that into their scoring if the fighter is using the Red Zone to avoid, delay or stall the action, and deduct points. Red Zone boxing carries less value than both Blue Zone boxing and White Zone boxing and is scored accordingly. Additionally, when a fighter steps in the Red Zone, the referee may halt the action and deduct a point from the offending fighter if, in the referee's judgment, a fighter has retreated to the Red Zone in order to avoid, delay or stall the action. The referee may then usher/command the fighters to the center of the ring and the round shall resume. A round may be scored as a tie.

In an embodiment, at the end of each round, the judges' scores for the round and the total score to that point may be displayed to the live audience on a prominently displayed scoreboard. In addition to the judges' scores for the round, the scoreboard may display additional data including total punches thrown, total punches landed, percentage of punches landed, number of each type of punch thrown (e.g., jab, hook, etc.), or any other relevant data about the fight or the fighters. This data may also be provided to the producer of the television broadcast for incorporation into the televised fight in real time, on a round-by-round basis, or at the conclusion of the match.

In an embodiment, a score awarded by the audience may be incorporated into each fighter's score. For example, in an embodiment, two live judges score the fight as normal and the live spectators and/or remote audience are polled and the scores averaged to take the place of a third judge. The audience may register their vote by a system installed at each seat in the arena, by text message to a central server, or any other method.

In an embodiment, a scoring computer may be used to assist the judges and/or live audience in scoring the match. The scoring computer may gather and process the judges' scores or gather other information about the match including total punches thrown, total punches landed, percentage of punches landed, number of each type of punch thrown (e.g., jab, hook, etc.), or any other relevant data about the fight or the fighters and, using the methods disclosed herein, compute the score. In an embodiment, the scoring computer is used to collect information about the fight for display on a scoreboard or transmission to a remote location.

Alternate scoring systems may be employed without deviating from the scope of the invention. For example, in amateur boxing, which is played at the collegiate level and in the Olympics, a different scoring system is used. Points are awarded for each clean punch landed on the opponent with the winner being the fighter who has acquired the most points over the course of the match. Using the system and method of the current invention to conduct such a match, points may be awarded only for clean punches landed while the fighter is boxing in the Blue Zone. Half points are awarded for clean punches landed in the White Zone, and no points may be awarded while fighting in the Red Zone. Additionally, when a fighter steps in the Red Zone, the referee may halt the action and deduct a point from the offending fighter if, in the referee's judgment, a fighter has retreated to the Red Zone in order to avoid, delay or stall the action.

As will be appreciated by persons of skill in the art, the system and method of the present invention can be adapted to any number of hand-to-hand combat sports including mixed martial arts, karate, fencing, and others where it is desirable to have participants in the center of the playing surface in close proximity to one another. The scoring systems and fighting areas of these sports may be modified to incorporate the novel multi-zone fighting surface of the present invention.

For example, in the sport of mixed martial arts (“MMA”), a polygonal fighting area is provided, typically with more than four sides, and may be enclosed with fencing. The sides and fencing define a fighting area that comprises a fighting surface that may be divided into three zones, namely, a Blue Zone, a White Zone and a Red Zone, which are similar to those defined above. Fewer than, or more than three zones may be used.

The MMA match comprises multiple rounds and is scored round-by-round by a panel of judges, preferably three. In each round, each judge awards a score to each fighter using the Ten Point Must System described above. Under the scoring system of the present invention, if the fighting is substantially contained within the Blue Zone during the round, the winner of the round may be awarded ten points and the loser may be awarded nine points. In the event that a fighter wins a round by a wide margin, the judges may deduct an additional point from the losing fighter for that round to award the dominating fighter. Such a judgment is subjective and it is not required that an additional point be deducted.

In addition to the foregoing scoring guidelines, should a fighter move outside the Blue Zone to the White Zone, the judges may factor that into their scoring if the fighter is using the White Zone to avoid, delay or stall the action. White Zone fighting carries less value than Blue Zone fighting and the judges may deduct points for retreating to the White Zone or award fewer points than would be awarded in the Blue Zone. Should a fighter move further still from the White Zone to the Red Zone, the judges may factor that into their scoring if the fighter is using the Red Zone to avoid, delay or stall the action, and deduct points. Red Zone fighting carries less value than both Blue Zone fighting and White Zone fighting and is scored accordingly. Additionally, when a fighter steps in the Red Zone, the referee may halt the action and deduct a point from the offending fighter if, in the referee's judgment, a fighter has retreated to the Red Zone in order to avoid, delay or stall the action. The referee may then usher/command the fighters to the center of the ring and the round shall resume. A round may be scored as a tie.

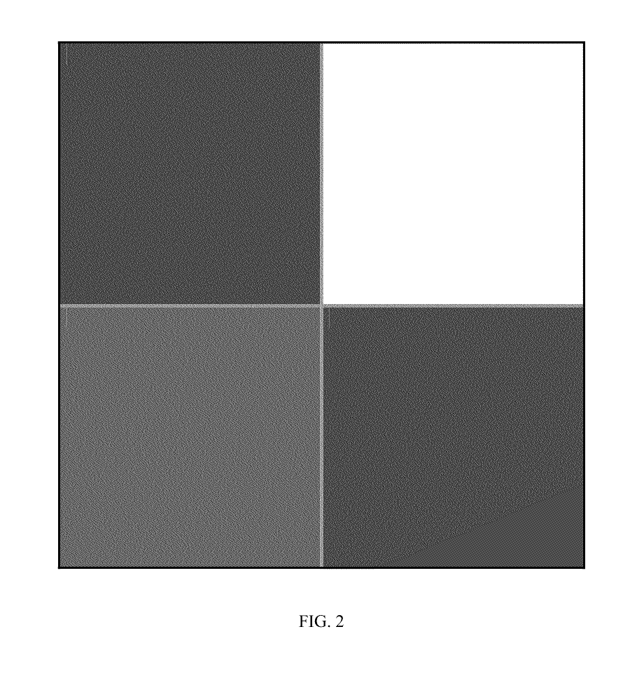

In an alternative embodiment, the fighting surface is subdivided into a plurality of adjacent non-concentric shapes. For example, referring to FIG. 2, a fighting surface is divided into four zones, each comprising a quarter of the fighting surface and representing a Green Zone, White Zone, Blue Zone, and Red Zone. Consistent with the scoring guidelines described above, in this embodiment, Green Zone boxing has the highest value, followed in decreasing order by Blue Zone boxing, White Zone boxing, and Red Zone boxing. As with the other embodiments, should a fighter move to a lower-ranked zone, the judges may factor that into their scoring if the fighter is using the White Zone to avoid, delay or stall the action.

In one embodiment, an audio and/or visual depiction of a match conducted in accordance with the present invention is broadcast to a remote audience. The broadcast signal may include the judges' scores for the round and the total score to that point, as would be displayed on a scoreboard before the live audience. Additional data may be incorporated into the transmission including total punches thrown, total punches landed, percentage of punches landed, number of each type of punch thrown (e.g., jab, hook, etc.), or any other relevant data about the fight or the fighters. In embodiments where a score awarded by the audience is incorporated into each fighter's score, this information may be included in the broadcast signal. In one embodiment, the foregoing match data and audience score may be transmitted independent of the video and/or audio signal.

It will be appreciated by persons of skill in the art that the term “broadcast” encompasses standard television transmission, cable television, satellite, Internet streaming, CCTV, radio or other medium where an audio and/or video signal representing the match is transmitted to a receiver.

Now that exemplary embodiments of the present invention have been shown and described in detail, various modifications and improvements thereon will become readily apparent to those skilled in the art. Accordingly, the spirit and scope of the present invention is to be construed broadly and limited only by the appended claims, and not by the foregoing specification.

What is claimed is:

1. A method for playing a hand-to-hand combat sport comprising the steps of:
providing a fighting area comprising a fighting surface;
wherein the fighting surface is subdivided into a plurality of zones including at least: (i) a first zone situated at the center of the fighting area and (ii) one or more zones surrounding the first zone which comprise the remainder of the fighting surface;
scoring the match according to a predetermined set of rules;
awarding a standard number of points based on performance to a fighter while the fighter is fighting in the first zone;
awarding less than standard points based on performance to a fighter when the fighter is fighting in a zone other than the first zone,
and deducting points when a fighter has retreated to a zone other the first zone to avoid, delay or stall the match.

2. The method of claim 1 wherein the fighting surface is divided into three zones.

3. The method of claim 2 wherein the points awarded while fighting in the third zone are less than the points awarded in the second zone.

4. The method of claim 1 wherein the hand-to-hand combat sport is boxing.

5. The method of claim 1 wherein the method further includes the step of using a scoring computer to score the match.

6. The method of claim 1 wherein the hand-to-hand combat sport is a sport chosen from the list of mixed martial arts, judo, karate, taekwondo, jujitsu, and wing chun.

7. The method of claim 1 wherein the hand-to-hand combat sport is boxing.

8. The method of claim 1 wherein the opinion of a live or televised audience is factored into the scoring of the match.

9. A method of broadcasting a hand-to-hand combat match comprising the steps of:
providing a fighting area comprising a fighting surface;
wherein the fighting surface is subdivided into a plurality of zones including at least: (i) a first zone situated at the center of the fighting area and (ii) one or more zones surrounding the first zone which comprise the remainder of the fighting surface;
scoring the match according to a predetermined set of rules;
awarding a standard number of points based on performance to a fighter while the fighter is fighting in the first zone;
awarding less than standard points based on performance to a fighter when the fighter is fighting in a zone other than the first zone;
deducting points when a fighter has retreated to a zone other the first zone to avoid, delay or stall the match; and
transmitting an audio and/or visual signal depicting the match to a remote audience.

10. The method of claim 9 wherein the fighting surface is divided into three zones.

11. The method of claim 10 wherein the points awarded while fighting in the third zone are less than the points awarded in the second zone.

12. The method of claim 9 wherein the hand-to-hand combat sport is boxing.

13. The method of claim 9 wherein the hand-to-hand combat sport is a sport chosen from the list of mixed martial arts, judo, karate, taekwondo, jujitsu, and wing chun.

14. The method of claim 11 wherein the hand-to-hand combat sport is boxing.

15. The method of claim 9 wherein the opinion of the live or televised audience is factored into the scoring of the match.

16. A hand-to-hand combat fighting area comprising:
a raised platform substantially covered with a layer of padding;
a plurality of posts surrounding said platform at regular intervals;
means for connecting said posts;
wherein said posts and said means for connecting said posts define a fighting area that comprises a fighting surface;
wherein said fighting surface is subdivided into a plurality of zones including: (i) a first zone situated at the center of the boxing area; and (ii) one or more zones surrounding said first zone.

17. The hand-to-hand fighting area of claim 16 wherein said means for connecting said posts is a plurality of padded ropes extending between said posts.

18. The hand-to-hand fighting area of claim 16 wherein said means for connecting said posts is a fence.

19. The hand-to-hand fighting area of claim 16 wherein said raised platform has more than four sides.

20. A method for playing a hand-to-hand combat sport comprising the steps of:
providing a fighting area comprising a fighting surface wherein the fighting surface is subdivided into a plurality of adjacent zones;
scoring the match according to a predetermined set of rules;
awarding a standard number of points based on performance to a fighter while the fighter is fighting in the first zone;
awarding less points based on performance to a fighter when the fighter is fighting in a zone other than the first zone,
and deducting points when a fighter has retreated to a zone other the first zone to avoid, delay or stall the match.
